(19) United States
(12) Patent Application Publication
(10) Pub. No.: US 2012/0137252 A1
(43) Pub. Date: May 31, 2012

(54) GUI DEVICE AND GUI DISPLAY METHOD

(75) Inventor: Atsumi Inai, Osaka (JP)

(73) Assignee: Panasonic Corporation, Kadoma-shi ,Osaka (JP)

(21) Appl. No.: 13/389,005

(22) PCT Filed: Aug. 5, 2010
(86) PCT No.: PCT/JP2010/004929

§ 371 Date: Feb. 6, 2012

(30) Foreign Application Priority Data
Aug. 18, 2009 (JP) 2009-188870

(51) Int. Cl. G06F 3/048

(52) U.S. Cl. 715/824

(57) ABSTRACT

A GUI (Graphical User Interface) device includes a function detecting circuit for detecting whether a plurality of functions is valid or invalid, a controller for changing a display style of icons corresponding to the functions and an icon corresponding to function groups based on the detection done by the function detecting circuit, an OSD (On Screen Display) creating circuit for following a command from the controller and creating icons corresponding to the functions and the icon corresponding to the function groups, and a display section for displaying the icons created by the OSD creating circuit. When the functions are valid, the controller displays icons corresponding to the respective functions on one-to-one basis, and when the functions are invalid, the controller displays a single icon representing a function group, to which the invalid function belongs, in a display style indicating invalidity.

### TECHNICAL FIELD

The present invention relates to a GUI (Graphical User Interface) device including a display device, e.g. a display for TV or an LCD monitor, and a method for displaying GUI.

### BACKGROUND ART

There is a technique to press a button for calling GUI, thereby displaying some icons, and then select one of the icons for calling a function corresponding to the selected icon. This technique is known to the public.

For instance, as a GUI device described in Patent Literature 1 calls a function by selecting one of icons displayed on a screen, and in general, the icon and the function to be called are in a one-to-one basis correspondence. The style and the number of icons corresponding to respective functions cannot be changed, in general, by user's operation. Operation of a general GUI device used in television receiver (TV) 400 is described as an example with reference to FIG. 10, which is a block diagram illustrating a structure of this conventional GUI device.

Tuning circuit 401 amplifies and detects a signal received from broadcast receiving antenna 450, and then splits the signal into a video signal and an audio signal. Tuning circuit 401 outputs the video signal to video signal processing circuit 421. Tuning circuit 401 also outputs the audio signal to an audio signal processing circuit (not shown); however, the description thereof is omitted here.

Key-in circuit 411 receives a key-in pressed by a user through remote control 420 or a key-in pressed by the user through a button of the TV, and outputs the information to micro controller 413 about which key-in is pressed.

Micro controller 413 receives the key-in pressed by the user from key-in circuit 411, and controls tuning circuit 401 for selecting any channel from broadcasting electric waves received by antenna 450. Controller 413 controls video signal processing circuit 421 for outputting the video of the selected channel to display device driving circuit 422, whereby the video signal desired by the user can be displayed on display section 423. Micro controller 413 can also control OSD (On Screen Display) creating circuit 414 for displaying any letters or graphic items on display section 423.

OSD creating circuit 414 receives a command from micro controller 413 for generating RGB signals of letters and graphic illustrations, and supplies the RGB signals to video signal processing circuit 421. When micro controller 413 receives a key-in pressed by the user through key-in circuit 411 and recognizes that the key-in is for displaying an icon, controller 413 issues a command to OSD creating circuit 414 for creating icons corresponding to functions on one-to-one basis. Then OSD creating circuit 414 outputs the icons to video signal processing circuit 421.

Video signal processing circuit 421 adjusts video signals supplied from tuning circuit 401, or receives the RGB signals of letters and graphic illustrations from OSD creating circuit 414 and superposes the RGB signals on the video signals, thereby supplying adjusted RGB video signals to display device driving circuit 422.

Display device driving circuit 422 amplifies the adjusted RGB video signals appropriately for a form of display section 423 for displaying the signals on display section 423.

The icons displayed on display section 423 are described hereinafter with reference to FIG. 11 which schematically illustrates a conventional display of icons.

In general, an icon for calling a function always corresponds to the function on one-to-one basis relation. For instance, as shown in FIG. 11, function group A includes functions A1, A2, A3, A4, and they correspond to icons 511, 512, 513, 514 respectively on one-to-one basis. In other words, four icons are displayed for four functions. Assume that function group B has functions B1, B2, B3, and icons 521, 522, 523 correspond to those functions respectively on one-to-one basis relation, and yet function group B has totally different properties, conditions of valid or invalid regarding the functions from those of function group A. In this case, three icons, i.e. an equal quantity to the number of functions, are displayed. An array of icons corresponding to functions on one-to-one basis thus occupies an area, proportional to the number of functions, on display section 423. A large number of icons will cover almost entire display section 423, so that a user cannot see a video thereon, or it makes difficult for the user to find a desirable function. In particular, when specific function groups are invalid, many of the icons corresponding to the functions thereof are also invalid; however, they still occupy uselessly a large area on display section 423.

To avoid the useless display of invalid icons on display section 423, two ways can be available: the icons are displayed by a page-split method so that a part thereof can be concealed, or the icons are displayed only when the corresponding functions are valid. However, the method for page-split display is not easy for users to switch a page instantly. Either one of those measures will spoil a function of “have-a-look” all the functions simultaneously.

The conventional GUI device, where icons corresponding to functions on one-to-one basis are displayed, makes the users difficult to select a desirable function in proportion to an increment of the number of icons. Since the icons cover a large area of the screen, multiple pages can be used for displaying a large number of icons; however, in this case the users cannot have a look of a part of the icons simultaneously. All the icons are displayed regardless of valid or invalid thereof, so that the display area is uselessly used when there are many invalid icons. Even if invalid icons are displayed, the functions thereof are not available, so that the icons cannot be used effectively.

### RELATED ART LITERATURE

Patent Literature 1: Unexamined Japanese Patent Application Publication No. 2008-289014

### DISCLOSURE OF INVENTION

The GUI device of the present invention comprises the following structural elements:
a function detecting circuit;
a controller;
an OSD creating circuit; and
a display section.

The function detecting circuit detects whether a plurality of functions is valid or invalid. The controller changes a display style of icons corresponding to functions and an icon corresponding to function groups based on a result of the detection by the function detecting circuit. The OSD creating circuit creates the icons corresponding to the functions and the icon corresponding to the function groups according to a command of the controller. The display section displays the icons created by the OSD creating circuit. The controller displays icons corresponding to the individual functions on one-to-one basis when the functions are valid, and displays a single icon representing a function group in a display style indicating invalidity when one of the functions is invalid.

The foregoing structure allows displaying icons of valid functions and a single icon of an invalid function group, whereby the screen can be efficiently used.

A method for displaying the GUI of the present invention comprising the steps of:
detecting whether multiple functions are valid or invalid by using the function detecting circuit;
changing a display style, by using the controller, of icons corresponding to functions and an icon corresponding to function groups based on a result of the detection by the function detecting circuit;
creating the icons corresponding to the functions and the icon corresponding to the function groups by using the OSD creating circuit according to a command of the controller;
displaying the icons created by the OSD creating circuit on the display section; and
displaying, by using the controller, the icons corresponding to valid functions on one-to-one basis and only one icon representing a function group in a display style indicating invalidity of a function thereof.

### BRIEF DESCRIPTION OF DRAWINGS

FIG. 1 is a block diagram illustrating a structure of a GUI device in accordance with a first embodiment of the present invention.

FIG. 2A schematically shows how icons are displayed in accordance with the first embodiment of the present invention.

FIG. 2B schematically shows how icons are displayed in accordance with the first embodiment of the present invention.

FIG. 3 is a flowchart illustrating how the GUI device operates in accordance with the first embodiment of the present invention.

FIG. 4 is a block diagram illustrating a structure of a GUI device in accordance with a second embodiment of the present invention.

FIG. 5 is a flowchart illustrating how the GUI device operates in accordance with the second embodiment of the present invention.

FIG. 6 is a block diagram illustrating a structure of a GUI device in accordance with a third embodiment of the present invention.

FIG. 7 is a flowchart illustrating how the GUI device operates in accordance with the third embodiment of the present invention.

FIG. 8 is a block diagram illustrating a structure of a GUI device in accordance with a fourth embodiment of the present invention.

FIG. 9 is a flowchart illustrating how the GUI device operates in accordance with the fourth embodiment of the present invention.

FIG. 10 is a block diagram illustrating a structure of a conventional GUI device.

FIG. 11 schematically illustrates a conventional display of icons.

### PREFERRED EMBODIMENTS FOR CARRYING OUT INVENTION

### Embodiment 1

When a user makes a key-in by depressing a button of a remote control and prompts a key-in circuit to operate the GUI (Graphical User Interface) for displaying an icon in order to call a function, the GUI device in accordance with the first embodiment determines whether or not the function is valid and then displays the icon corresponding to the valid function on one-to-one basis correspondence. On the other hand, when the function is invalid, the GUI device displays a single icon representing a function group, to which the invalid function belongs, in a display style indicating invalidity (e.g. with some color or design). The GUI device in accordance with this first embodiment can have a guiding function that teaches the user how to change the invalid state of the selected function to a valid state. The first embodiment is demonstrated hereinafter with reference to the accompanying drawings.

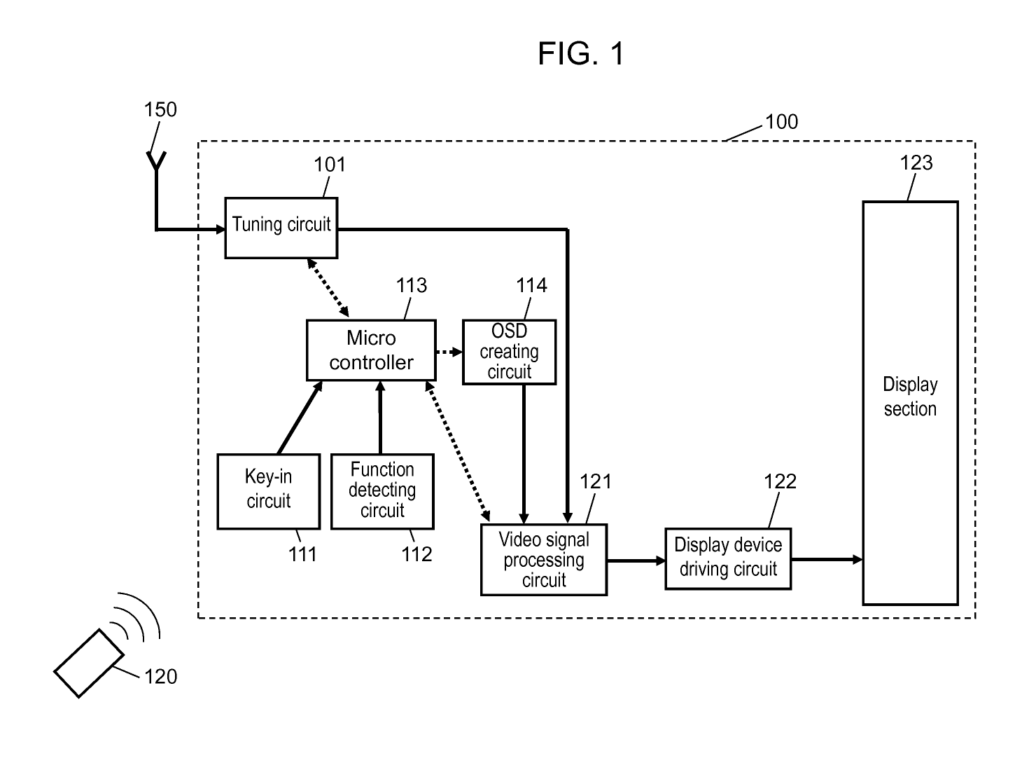

FIG. 1 is a block diagram illustrating a structure of the GUI device in accordance with the first embodiment. Television receiver (TV) 100 is taken as an example of the GUI device, and TV 100 includes tuning circuit 101, key-in circuit 111, function detecting circuit 112, micro controller 113 as a controller, OSD creating circuit 114, video signal processing circuit 121, display device driving circuit 122, and display section 123. Tuning circuit 101 selects a specific channel from the broadcasting electric waves received for obtaining video signals and audio signals. Key-in circuit 111 receives a key-in from remote control 120 or a key-in through a button of TV 100. Function detecting circuit 112 detects whether a function of an icon is valid or invalid. Micro controller 113 controls each one of the circuits of TV 100. OSD (On Screen Display) creating circuit 114 displays GUI for prompting a user to input necessary settings. Video signal processing circuit 121 adjusts the video signals. Display device driving circuit 122 amplifies the adjusted RGB video signals supplied from video signal processing circuit 121 appropriately for a form of display section 123, and outputs the amplified signals to display section 123. Display section 123 displays videos or GUI. TV 100 is connected with broadcast receiving antenna 150 for receiving the broadcasting electric waves.

Tuning circuit 101 amplifies and detects a signal received by antenna 150, and splits the signal into a video signal and an audio signal, and then outputs the video signal to video signal processing circuit 121. Tuning circuit 101 also outputs the audio signal to an audio signal processing circuit; however, the description thereof is omitted here.

Key-in circuit 111 receives a key-in pressed by a user from remote control 120 or a key-in through a button of TV 100, and supplies information to micro controller 113 about which key-in is received.

Function detecting circuit 112 detects whether the respective functions of TV 100 are valid or invalid, and supplies the result to micro controller 113.

For instance, assume that an IP network connecting function is one of the functions of TV 100, function detecting circuit 112 has a similar function to that of an Ethernet Transceiver LSI, and detects a connection via cable or radio to the Internet, and then supplies the detection result to micro controller 113. Assume that a picture quality adjusting circuit is one of the functions of TV 100, then function detecting circuit 112 detects whether or not the picture quality adjusting function is set valid for the users, and reports the status set for the users to micro controller 113.

Micro controller 113 receives a key-in pressed by the user from key-in circuit 111 for controlling tuning circuit 101 such that circuit 101 selects some channel from the broadcasting electric waves received by antenna 150. Micro controller 113 controls video signal processing circuit 121 such that circuit 121 outputs the video of the selected channel to display device driving circuit 122 for displaying a video source desired by the user on display section 123. On top of that, based on a result of the detection by function detecting circuit 112, micro controller 113 controls OSD creating circuit 114 such that circuit 114 changes a display style of icons corresponding to a function and an icon corresponding to a function group depending on the state of the function, i.e. the function is valid or invalid. Micro controller 113 can also allow controlling OSD creating circuit 114 to display any letter or graphic item on display section 123.

Following the command from micro controller 113, and based on the detection done by circuit 112, OSD creating circuit 114 creates icons corresponding to a function and an icon corresponding to a function group in a display style reflecting the status of the function and the function group. OSD creating circuit 114 generates RGB signals of letters or graphic illustrations, and supplies them to video signal processing circuit 121.

Video signal processing circuit 121 adjusts the video signals supplied from tuning circuit 101, or receives the RGB signals, which represent icons, letters or graphic illustrations, supplied from OSD creating circuit 114, and them superposes them on the video for outputting adjusted RGB video signals to display device driving circuit 122.

Display device driving circuit 122 amplifies the adjusted RGB video signals, supplied from video signal processing circuit 121, appropriately for the form of display section 123, and outputs the amplified signals to display section 123, which namely displays the icons created by OSD creating circuit 114.

Display section 123 is a thin-flat display device, e.g. plasma display or liquid crystal display.

Broadcast receiving antenna 150 receives analog terrestrial broadcasting electric waves or satellite broadcasting electric waves, or digital terrestrial broadcasting electric waves or satellite broadcasting electric waves, and then supplies the received signals to tuning circuit 101.

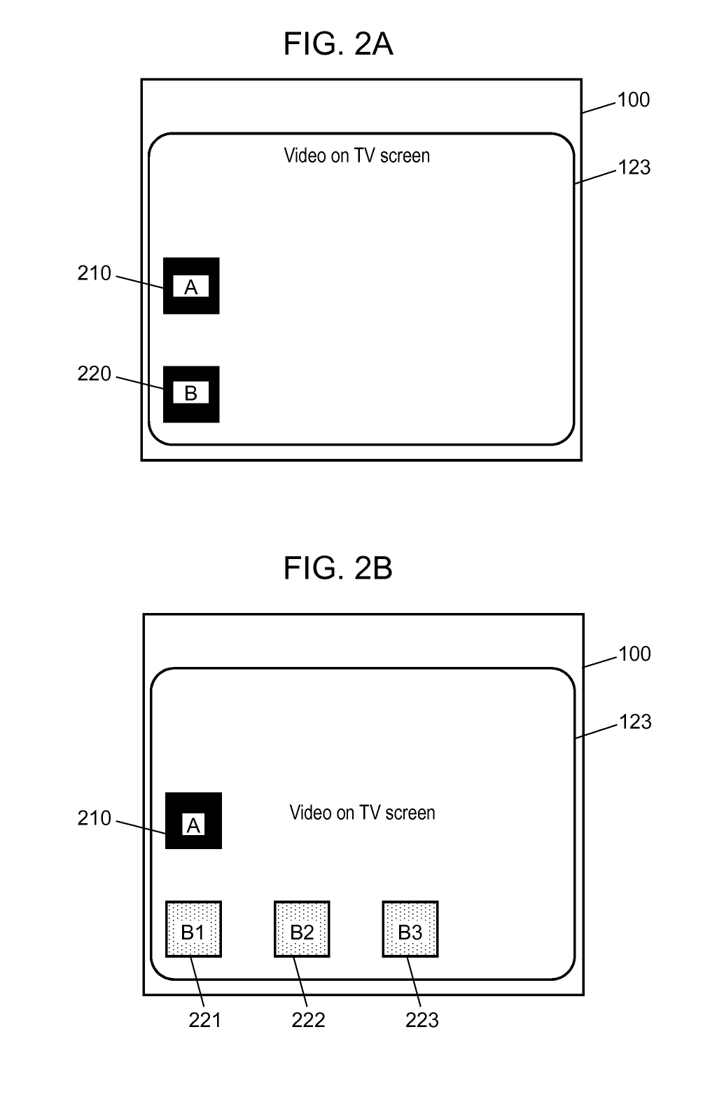

The icons displayed on display section 123 are described hereinafter. FIGS. 2A and 2B schematically illustrate displayed icons in accordance with the first embodiment. FIG. 2A shows a case where function groups A and B are invalid, and FIG. 2B shows a case where function group A is invalid and function group B is valid.

As shown in FIG. 2A, when function groups A and B are invalid, icons 210 and 220 representing groups A and B are displayed in a display style (with some color or design) indicating an invalid state. In a case where group A is invalid and group B is valid as shown in FIG. 2B, icon 210 representing function group A is displayed in the display style indicating invalidity, and function group B is displayed in a display style (with some color or design) indicating that the icons 221-223 representing the functions are valid.

In other words, the GUI device in accordance with this first embodiment of the present invention displays a single icon 210 in a display style indicating invalidity of a function group of which validity or invalidity links to validity or invalidity of each function belonging to this function group. (The function group includes multiple functions directly or indirectly related to each other.) When functions are valid, the GUI device displays icons corresponding to the valid functions on one-to-one basis, i.e. in this case icons 221-223 are displayed. The GUI device thus allows avoiding an inefficient display of all the icons including invalid icons, or avoiding a problem of spoiling the function of have-a-look of all the icons simultaneously, where the problem has been caused by concealing parts of the icons.

When a user selects and enters icon 210 indicating that the function group is invalid, a display teaching the user how to make this function group valid will effectively guide the user to access respective functions.

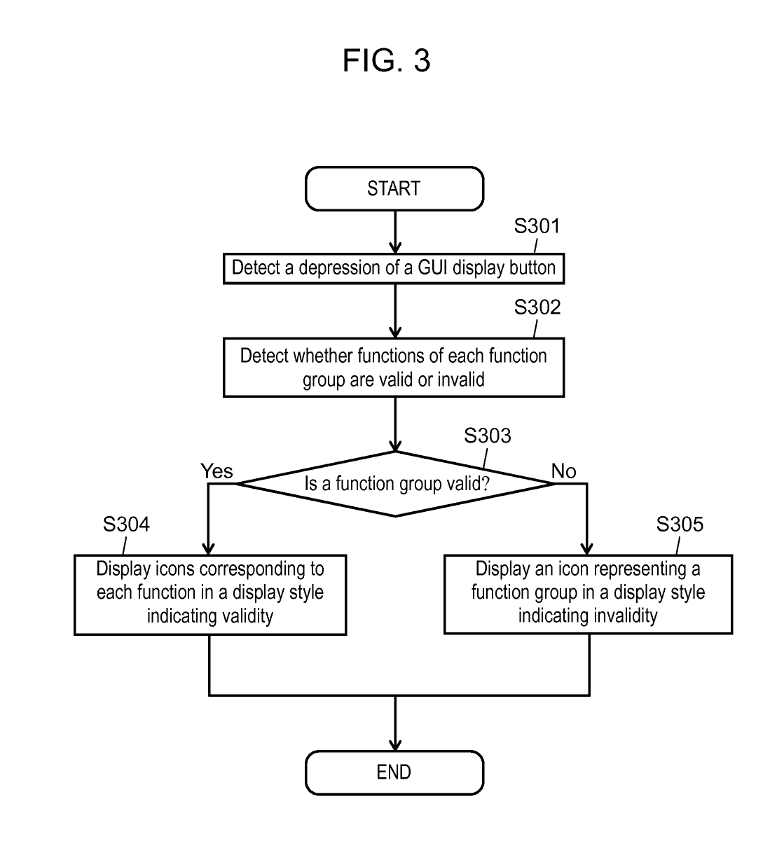

Operation of the foregoing GUI device is demonstrated hereinafter with reference to FIG. 3, which shows a flowchart illustrating the operation of the GUI device in accordance with the first embodiment.

First, a GUI-display button is depressed for displaying icons, and key-in circuit 111 detects and transmits this depression to micro controller 113 (step S301). Next, before the icons are displayed, micro controller 113 receives information from function detecting circuit 112 about whether the functions of each function group are valid or invalid (step S302). Then micro controller 113 determines whether or not the function groups are valid based on the information received from function detecting circuit 112 (step S303).

In step S303, when the function groups are valid (positive branch from the block of step S303), icons of each function are displayed in a display style indicating that the functions are valid. For this purpose, micro controller 113 controls OSD creating circuit 114 to display icons corresponding to functions on one-to-on base (step S304). Then, for instance, icons 221-223 of function group B are displayed as shown in FIG. 2B.

In step S303, when the function groups are invalid (negative branch from the block of step S303), icons indicating that the function groups are invalid are displayed as representatives of the respective function groups. For this purpose, micro controller 113 controls OSD creating circuit 114 to display a single icon representing each of the function groups (step S305). Then, for instance, icon 210 representing function group A is displayed as shown in FIG. 2B.

As discussed above, micro controller 113 working as a controller in this embodiment allows displaying icons corresponding to the individual functions on one-to-one basis when the functions are valid, and controller 113 also allows displaying a single icon representing a function group of which any function is invalid.

When the function group is invalid and a user selects and enters icon 210 that indicates invalidity, micro controller 113 controls OSD creating circuit 114 to display any one of guiding sentences and graphic illustrations which teach the user how to make the function group valid. This control allows the user to use the icons more efficiently even if some functions are invalid.

According to the foregoing structure, a single icon representing an invalid function group is displayed in a display style indicating invalidity, whereby icons representing valid functions can be displayed together with a single icon representing an invalid function group. As a result, the display screen can be used more efficiently.

### Embodiment 2

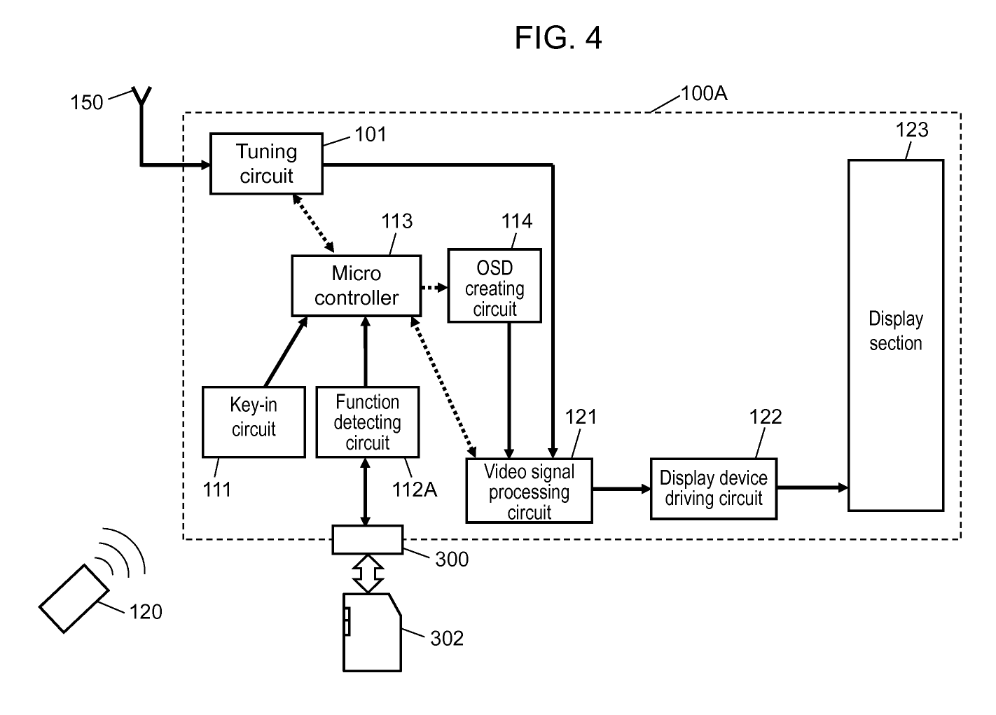

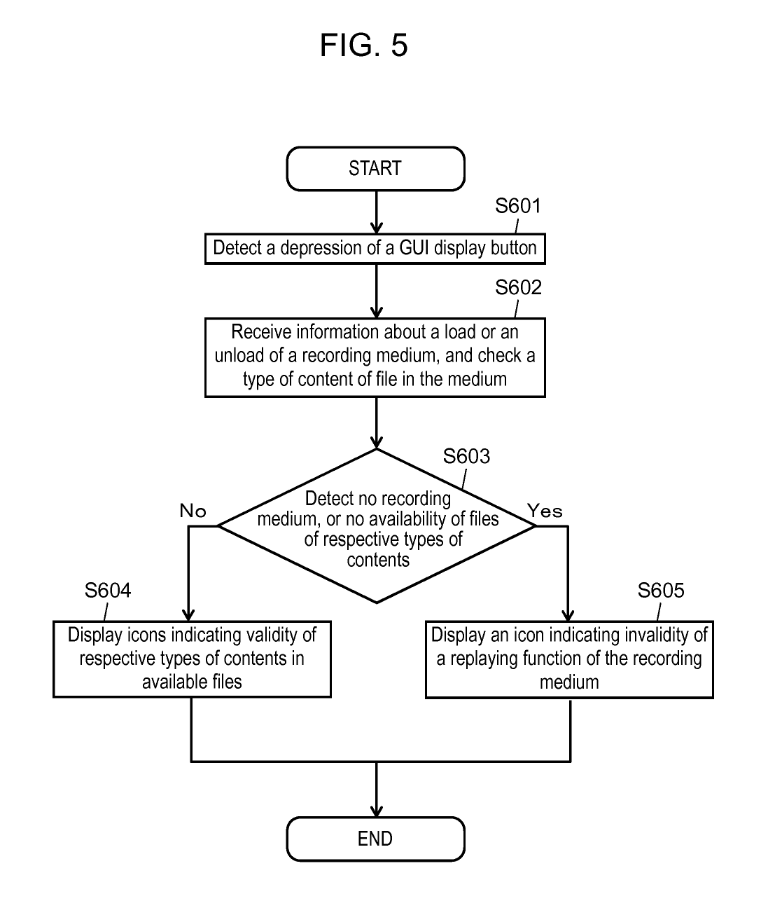

FIG. 4 is a block diagram of the GUI device in accordance with the second embodiment of the present invention. Similar elements to those used in the first embodiment have the same reference marks, and the descriptions thereof are omitted here. In the first embodiment discussed previously, function detecting circuit 112 detects whether multiple functions of TV 100 are valid or invalid as shown in FIG. 1. In this second embodiment, as shown in FIG. 4, TV 100A is used as an example of the GUI device, and function detecting circuit 112A of TV 100A detects a loading and unloading of recording medium 302. This is a different point from the first embodiment. To be more specific, the GUI device in accordance with the second embodiment displays function group B including functions of playing a still picture, moving picture, or music file. This instance is demonstrated hereinafter with reference to FIG. 4 and FIG. 5.

Recording medium 302 can be, e.g. memory card such as SD memory card, or a large capacity medium such as a hard disc drive. As shown in FIG. 4, recording medium 302 is loaded through external medium intake port 300. Function detecting circuit 112A detects the loading or unloading of recording medium 302, and transmits the data recorded on recording medium 302 to micro controller 113.

FIG. 5 is a flowchart illustrating operation of the GUI device in accordance with the second embodiment. The operation of the GUI device is demonstrated hereinafter with reference to FIG. 5. First, a GUI-display button is depressed for displaying icons, and key-in circuit 111 detects and transmits this depression to micro controller 113 (step S601). Next, before the icons are displayed, micro controller 113 receives information from function detecting circuit 112A about whether or not recording medium 302 is loaded through the intake port, and checks the types of contents contained in the files of medium 302 (step S602).

Next, micro controller 113 determines whether the playing function of medium 302 is invalid or not based on the information about the load of medium 302 and about the types of contents in the files (step S603).

In step S603, when the playing function of medium 302 is not invalid (negative branch from step S603 block), icons representing each type of contents such as still picture, moving picture, and music file are displayed in a display style indicating validity. For this purpose, micro controller 113 controls OSD creating circuit 114 to display the icons corresponding to each types of contents (step S604). For instance, as shown in FIG. 2B, icon 221 corresponding to still picture, icon 222 corresponding to moving picture, and icon 223 corresponding to music file are displayed as icons representing the playing function group of recording medium 302.

In step S603, when the playing function of medium 302 is invalid (positive branch from step S603 block), an icon indicating invalidity is displayed as a representative of the playing function of medium 302. For this purpose, micro controller 113 controls OSD creating circuit 114 to display a single icon representing the playing function group of recording medium 302 (step S605). For instance, as shown in FIG. 2A, icon 220 corresponding to the playing function of medium 302 is displayed.

The foregoing structure allows displaying a single icon in a display style indicating invalidity of a function group when a function thereof is invalid, thereby displaying icons representing valid functions together with the single icon representing the invalid function group. As a result, the display screen can be used more efficiently.

If a user selects and enters icon 220 indicating invalidity of the playing function of recording medium 302, micro controller 113 controls OSD creating circuit 114 to display guiding sentences or graphic illustrations for prompting the user to load recording medium 302 containing a reproducible file in order to make the playing function of medium 302 valid. This control allows using the icons more efficiently even when some function is invalid.

### Embodiment 3

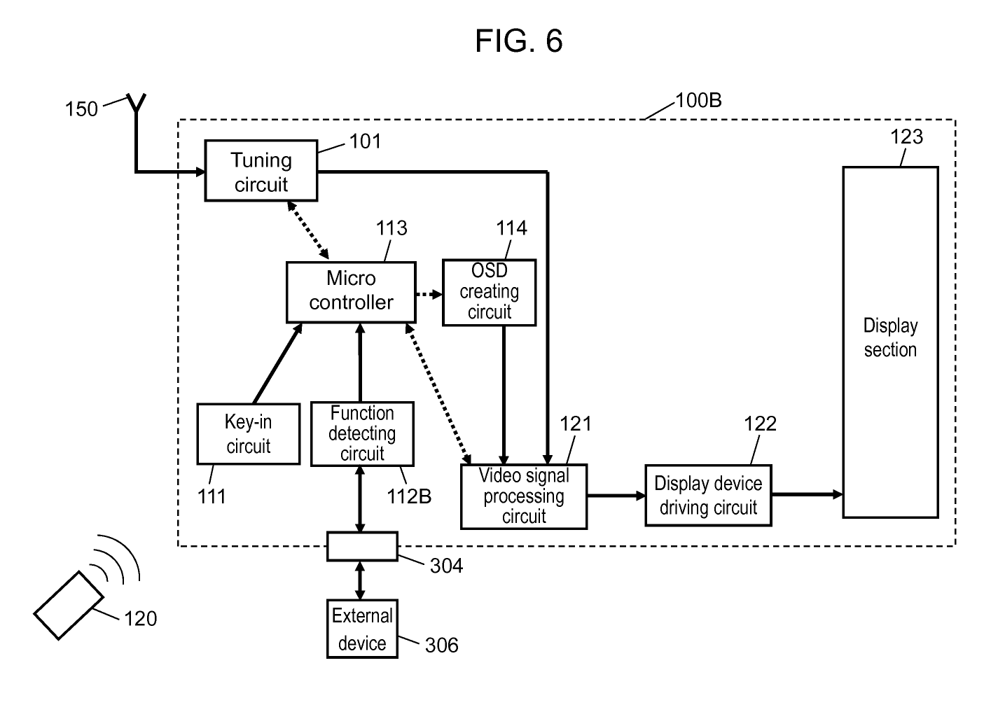

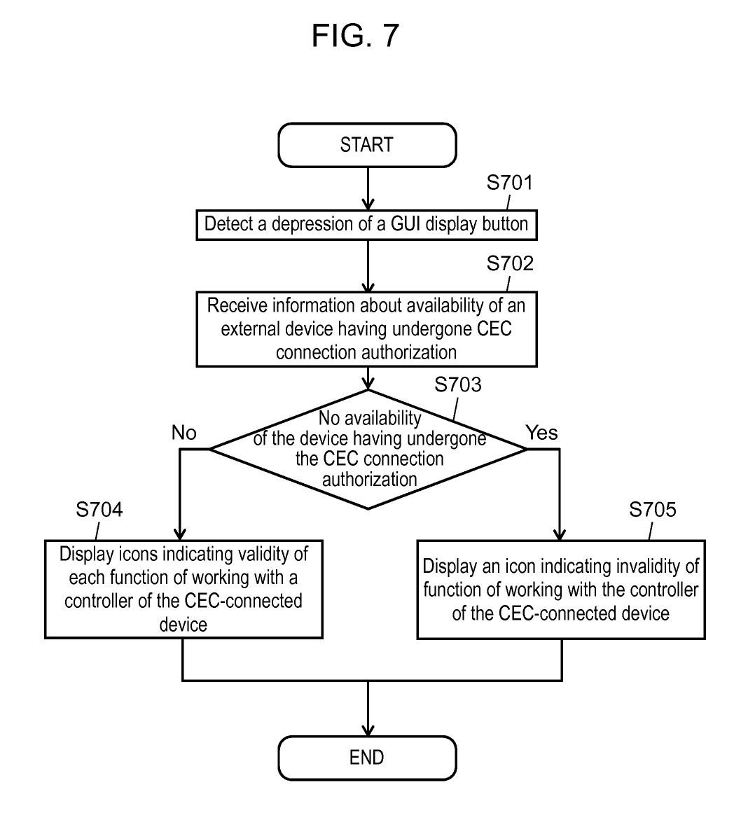

FIG. 6 is a block diagram of the GUI device in accordance with the third embodiment of the present invention. Structural elements similar to those used in the first embodiment have the same reference marks, and the descriptions thereof are omitted here. In the first embodiment discussed previously, function detecting circuit 112 detects whether multiple functions of TV 100 are valid or invalid as shown in FIG. 1. In this third embodiment, as shown in FIG. 6, TV 100B is used as an example of the GUI device, and function detecting circuit 112B of TV 100B detects a CEC (Consumer Electronics Control) connection authorization of external device 306 connected to TV 100B via HDMI (High-Definition Multimedia Interface) cable. This is a different point from the first embodiment. To be more specific, the GUI device in accordance with the third embodiment displays function group B as a function working with a device connected to the GUI device with the aid of HDMI-CEC control. This instance is demonstrated hereinafter with reference to FIG. 6 and FIG. 7.

External device 306 is connected to TV 100B with the HDMI cable through HDMI port 304. External device 306 can be, e.g. a recording device or an AV amplifier including a hard disc drive having a connecting function through HDMI. FIG. 6 shows only one external device 306 for a simple description purpose, so that the number thereof is not limited to one unit.

FIG. 7 is a flowchart illustrating operation of the GUI device in accordance with the third embodiment. The operation of this GUI device is demonstrated hereinafter with reference to FIG. 7. First, a user depresses a GUI display button for displaying an icon, and key-in circuit 111 detects this depression and transmits it to micro controller 113 (step S701). Next, before displaying icons, micro controller 113 receives information from function detecting circuit 112B about an availability of external device 306 having undergone CEC connection authorization (step S702). Then micro controller 113 determines whether the CEC connected device work invalidly with controller 113 based on the information received from function detecting circuit 112B. In other words, micro controller 113 confirms that there is no external device having undergone the CEC connection authorization (step S703).

In step S703, when external device 306 with CEC connection authorization is detected (negative branch from S703 block), icons indicating validity are displayed for each one of the functions, which work with controller 113, of external device 306. To be more specific, micro controller 113 controls OSD creating circuit 114 to display the icons corresponding to the functions, which work with controller 113, on one-to-one basis (step S704). For instance, as shown in FIG. 2B, icons 221-223 are displayed, where the following functions are assigned to each icon:

icon 221: corresponding to the function of calling the GUI for operating external device 306 and representing the function group working with controller 113;

icon 222: switching a speaker of TV 100B to/from a speaker of an AV amplifier connected to TV 100B to produce sound; and

icon 223: corresponding to the function of prompting a recording device to start immediately a video recording.

When a user selects icon 221, 222, and 223, the GUI device implements the functions corresponding to those icons.

In step S703, when no device having undergone the CEC connection authorization is available (positive branch from S703 block), an icon is displayed in a display style indicating invalidity as a representative of the function group, working with controller 113, of external device 306 having undergone the CEC connection authorization. For this purpose, micro controller 113 controls OSD creating circuit 114 to display a single icon representing the function group, which works with controller 113, of the CEC-connected device (step S705). For instance, as shown in FIG. 2A, icon 220 is displayed for representing the function, which works with controller 113, of the device having undergone the CEC connection authorization.

As discussed above, the GUI device in accordance with the third embodiment includes HDMI port 304 to be connected with external device 306. Function detecting circuit 112B has the function of coordinating external device 306 connected to HDMI port 304, and transmits the information about the validity or invalidity of external device 306 to micro controller 113 working as a controller.

The foregoing structure allows displaying, in a display style indicating invalidity, a single icon representing a function group when a function thereof is invalid, so that icons representing valid functions can be displayed together with the single icon representing the invalid function group. As a result, the display screen can be used more efficiently.

When a user selects and enters icon 220 indicating invalidity when no external device 306 having undergone the CEC connection authorization is available, micro controller 113 controls OSD creating circuit 114 to display guiding sentences or graphic illustrations to teach the user how to enable the CEC-connected device to work with controller 113. This mechanism allows using more efficiently the icon even if the function thereof is invalid.

### Embodiment 4

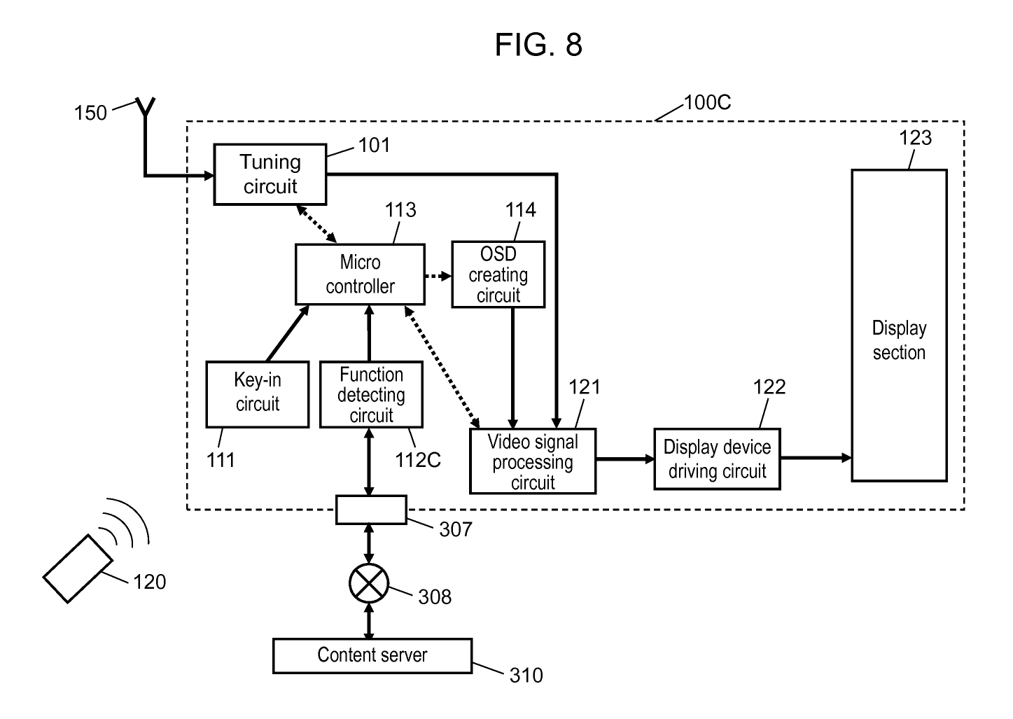

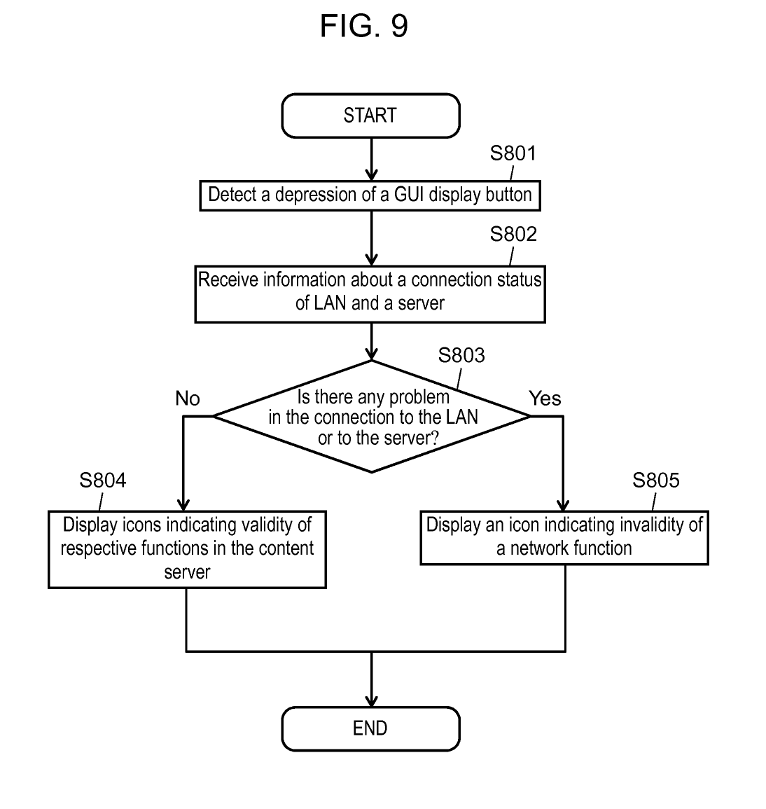

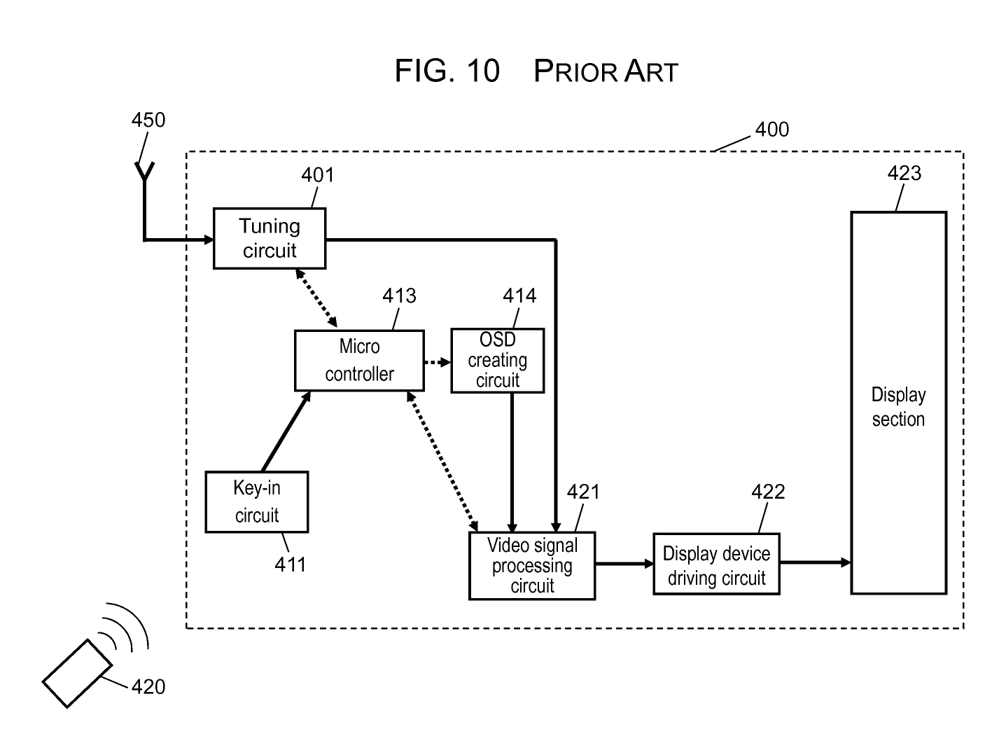

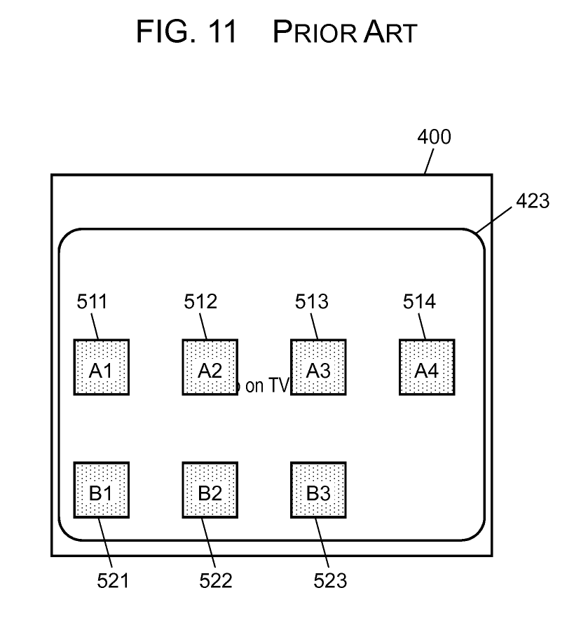

FIG. 8 is a block diagram of the GUI device in accordance with the fourth embodiment. Structural elements similar to those used in the first embodiment have the same reference marks, and the descriptions thereof are omitted here. In the first embodiment previously described, function detecting circuit 112 detects whether each one of multiple functions of TV 100 is valid or invalid as shown in FIG. 1. In this fourth embodiment, as shown in FIG. 8, TV 100C is used as an instance of the GUI device, and function detecting circuit 112C thereof detects whether or not the GUI device normally connected to LAN and to content server 310. This is a different point from the first embodiment. To be more specific, the GUI device displays function group B representing the function of receiving an AV stream or information from content server 310 connected to an IP network. This example is demonstrated hereinafter with reference to FIGS. 8 and 9.

FIG. 9 is a flowchart illustrating operation of the GUI device in accordance with the fourth embodiment of the present invention. The operation of the GUI device is demonstrated with reference to FIG. 9. First, a user depresses a GUI-display button for displaying an icon, and then key-in circuit 111 detects this depression, and transmits it to micro controller 113 (step S801). Next, before displaying the icon, micro controller 113 receives, from function detecting circuit 112C, the information about the connection status of the LAN and content server 310 (step S802). Function detecting circuit 112C detects whether or not the GUI device is connected normally to the LAN and to content server 310. Micro controller 113 receives the information from function detecting circuit 112C about the connection status, and determines whether the function of receiving the AV stream or information via the IP network is valid or not, and then confirms that there is no problem in the connections between the GUI device and the LAN, and between the GUI device and content server 310 (step S803).

In step S803, when normal connections between the GUI device and the LAN, and between the GUI device and content server 310 are detected (negative branch from S803 block), the information is sent to micro controller 113 working as a controller about whether or not content information of each content function stored in content server 310 is valid. Micro controller 113 then displays icons, in a display style indicating validity of the content information, corresponding to each function of the contents stored in server 310. Micro controller 113 controls OSD creating circuit 114 to display icons corresponding to the contents on one-to-one basis (step S804). For instance, as shown in FIG. 2B, icons 221-223 are displayed, where the following functions are assigned to each icon:

icon 221: corresponding to the function of calling the GUI for displaying content A and representing the function group receiving an AV stream and information;

icon 222: corresponding to another content B; and

icon 223: corresponding to still another content C.

When the user selects icon 221, 222, and 223, the GUI device implements the functions corresponding to those icons.

In step S803, when normal connections to the LAN and to content server 310 are not detected, in other words, when some problem happens in the connection to the LAN and to server 310 (positive branch from S803 block), micro controller 113 displays an icon indicating invalidity of the content information as a representative of the function of receiving and displaying the AV stream and information. For this purpose, micro controller 113 controls OSD creating circuit 114 to display a single icon representing the function group of receiving and displaying the AV stream and information via the IP network (step S805). For instance, icon 220 corresponding to the foregoing function is displayed as shown in FIG. 2A.

As discussed above, the GUI device in accordance with this fourth embodiment includes network connecting port 307 for connecting to network 308. Function detecting circuit 112C transmits the information to the controller about whether information of content, stored in server 310 connected to the GUI device via network 308, for each content function is valid or invalid.

The foregoing structure allows displaying, in a display style indicating invalidity, a single icon representing a function group when a function thereof is invalid, so that icons representing valid functions can be displayed together with the single icon representing the invalid function group. As a result, the display screen can be used more efficiently.

When connections to the LAN and to content server 310 are not detected and a user selects and enters icon 220 indicating invalidity of the function, micro controller 113 controls OSD creating circuit 114 to display guiding sentences or graphic illustrations for teaching the user how to connect the LAN and content server 310 to the GUI device so that the function can be valid. This mechanism allows using the icon more efficiently even if the function thereof is invalid.

### INDUSTRIAL APPLICABILITY

The GUI device and the method for displaying the GUI of the present invention are useful for a user to select functions corresponding to multiple icons displayed on a display section of a TV display or an LCD monitor screen. The present invention is useful particularly for a device which includes many functions and displays a large number of icons.

### DESCRIPTION OF REFERENCE MARKS

100, 100A, 100B, 100C television receiver (TV)
101 tuning circuit
111 key-in circuit
112, 112A, 112B, 112C function detecting circuit
113 micro controller
114 OSD creating circuit
120 remote controller
121 video signal processing circuit
122 display device driving circuit
123 display section
150 broadcast receiving antenna
210, 220 icon representing a function group
221, 222, 223 icon representing a function
300 external medium intake port
302 recording medium
304 HDMI port
306 external device
307 network connecting port
308 network
310 content server

1. A GUI (Graphical User Interface) device comprising:
a function detecting circuit for detecting whether a plurality of functions is valid or invalid;
a controller for changing a display style of icons corresponding to the functions and a display style of an icon corresponding to a function group based on a result of the detection by the function detecting circuit;
an OSD (On Screen Display) creating circuit for creating the icons corresponding to the functions and the icon corresponding to the function group according to a command of the controller; and
a display section for displaying the icons created by the OSD creating circuit,
wherein the controller displays the icons corresponding to the individual functions on one-to-one basis when the functions are valid, and displays the single icon representing the function group in a display style indicating invalidity when one of the functions is invalid.

2. The GUI device according to claim 1, wherein the controller displays any of a guiding sentence and a graphic illustration to teach a user how to make the function group valid when the user has selected the icon representing the invalid function group.

3. The GUI device according to claim 1 further comprising an external medium intake port through which a recording medium is loaded, wherein the function detecting circuit transmits information to the controller about loading or unloading of the recording medium into the external medium intake port.

4. The GUI device according to claim 1 further comprising an HDMI (High-Definition Multimedia Interface) port to be connected with an external device, wherein the function detecting circuit has a function of coordinating the external device connected to the HDMI port and transmits information to the controller about availability of the external device.

5. The GUI device according to claim 1 further comprises a network connecting port for connecting to a network, wherein the function detecting circuit transmits information to the controller about a connection status with the network and a connection status of a predetermined content server.

6. A method for displaying GUI (Graphical User Interface), the method comprising the steps of:
detecting whether a plurality of functions is valid or invalid by using a function detecting circuit;
changing a display style, by using a controller, of icons corresponding to the functions and an icon corresponding to a function group based on a result of the detection by the function detecting circuit;
creating the icons corresponding to the functions and the icon corresponding to the function group by using an OSD (On Screen Display) creating circuit according to a command of the controller;
displaying the icons created by the OSD creating circuit on a display section; and
displaying the icons corresponding to the functions on one-to-one basis when the functions are valid, and displaying the single icon representing the function group in a display style indicating invalidity when one of the functions of the function group is invalid.

7. The method according to claim 6, wherein when a user selects the icon indicating invalidity of the function group, the controller displays any of a guiding sentence and a graphic illustration for teaching the user how to make the function group valid.

8. The method according to claim 6, wherein the function detecting circuit transmits information to the controller about loading or unloading of a recording medium into an external medium intake port.

9. The method according to claim 6, wherein the function detecting circuit has a function of coordinating an external device connected to an HDMI (High-Definition Multimedia Interface) port, and transmits information to the controller about availability of the external device.

10. The method according to claim 6, wherein the function detecting circuit transmits information to the controller about a connection status with a network and a connection status of a predetermined content server.
